(19) United States
(12) Patent Application Publication
(10) Pub. No.: US 2012/0192799 A1
(43) Pub. Date: Aug. 2, 2012

(54) Drainable Aquarium with Redundant Leak Prevention

(76) Inventor: Tommy Bazemore, SR., Edgewood, MD (US)

(21) Appl. No.: 13/351,271

(22) Filed: Jan. 17, 2012

Related U.S. Application Data
(60) Provisional application No. 61/437,284, filed on Jan. 28, 2011.

(51) Int. Cl. A01K 63/00

(52) U.S. Cl. 119/264

(57) ABSTRACT

A leak prevention drainage system integrated into the base of an aquarium tank is disclosed. The drainage system facilitates transfer of water to or from the interior of the tank, wherein the system comprises three leak prevention mechanisms to redundantly prevent unwanted spillage or leakage from the aquarium during operation. The leak prevention mechanisms include an uppermost stopper having a pull chain accessible from above the water level within the tank, a drain pipe having an internal drain valve for controller flow rate therethrough and a removable end cap at the exit end of the drain pipe. A screen within the drain prevents particulate items from passing therethrough, while a plurality of washers and threaded connections prevent water leakage through the elements of the drainage system. The system is used to controllably drain or fill an aquarium using a hose attachable to the end of the drain pipe.

### CROSS REFERENCE TO RELATED APPLICATION

This application claims the benefit of U.S. Provisional Application No. 61/437,284 filed on Jan. 28, 2011, entitled “Drainable Aquarium.”

### BACKGROUND OF THE INVENTION

1. Field of the Invention

The present invention relates to an improved means of draining water from, cleaning and refilling an aquarium tank. More specifically, the present invention relates to an integrated draining system that is incorporated into the base of an aquarium tank. The draining system of the present device employs multiple redundant leak prevention mechanisms intended to ensure against leakage through the elements of the system, and for controlling the flow of water from the tank during draining activity. Furthermore, the device provides a screen within the inside of the drain to prevent objects and debris from entering the drain while emptying the tank.

2. Description of the Prior Art

Many individuals enjoy keeping an aquarium in their home for the purpose of creating an aquatic environment in which to house aquatic pets. Fish are very popular aquatic pets and some breeds of fish can live in fresh water habitats while other fish varieties require a salt water environment. Less popular, but still common, are other aquatic pets, such as turtles, frogs, snails and hermit crabs, which all require aquatic environments to live in. Some individuals implement the use of an aquarium for housing an environment in which to grow coral. These aquatic environments generally require a high level of maintenance and dedication to maintain the health of the living organisms contained therewithin.

When animals live in a closed environment, waste byproducts can accumulate within that environment. Build up of these byproducts can be harmful to the animal's health. For aquariums, new water must be introduced into the environment in order to dilute the accumulated waste byproducts within the water, keeping their concentrations at a safe level for the animal to thrive. Performing a partial water change weekly helps maintain the accumulated waste byproduct levels at a safe concentration. To perform a partial water change, an individual siphons out a portion of the water in a tank, typically anywhere from a quarter to a third of the water in the tank, and replaces it with new water. Performing a partial water change in this fashion may improve the overall health of the environment and the pets contained therein. However, in aquatic environments wherein the bed of the tank is covered in decorative stone bedding, waste sinks to the bottom of the tank and accumulates in the stone bedding. Siphoning a portion of the water out of the tank may help reduce the waste byproduct concentration levels in the water, but it still leaves the source of the concentration levels—the waste itself—at the bottom of the tank, littered about the decorative stone bedding. In these situations, the bedding may eventually need replenishing, requiring complete drainage of the tank. This process is generally problematic given the size of the tank and its loose interior contents.

When attempting to perform a complete water change of an aquarium, an individual generally siphons off as much water as possible, and then tilts the tank onto its side to pour out any remaining water from inside the tank. This method requires that the aquatic animals be removed from the habitat and disrupts the bedding, plants or any tank decorations. Furthermore, some tanks are very large and heavy to move. These can be bulky and difficult to handle, and further result in damage to the tank if dropped or mishandled. A crack sustained along the walls or bottom of a tank renders the tank useless for water holding purposes. An effective solution is required that allows a tank to be fully and partially drained without physically moving the tank or disrupting the aquarium bed along its base.

The present invention is an aquarium with an integrated draining system incorporated into the base of the aquarium tank. The purpose of the present invention is to enable an individual to drain water and waste that has become sediment at the bottom of the aquarium out from the bottom of the tank without disturbing the habitat or aquatic life housed there within and without risking unwanted leakage or transfer through the system. The system then enables a user to refill the tank with clean water using the same system in reverse. A user first attaches a hose to a drain pipe hose fitting at the end of the system to create a conduit for discarded water. The water can be deposited into a sink, bucket or other disposal device, or recycled into the soil of water house plants. After connecting the drainage hose, a stopper located within the tank interior and plugging the entryway of the drain system can be removed from the drain, allowing water to fill the drainage pipe up to a closed valve. The valve is a pipe valve with user handle to control the flow therethrough to the hose fitting. Once opened, water is free to flow from the aquarium and into the connected hose. After this operation, the hose can be connected to a water pump or faucet for refilling the aquarium from the base and through the system in reverse.

The draining system of the present invention, therefore, has multiple mechanisms in place to prevent against leakage of the device. The first leakage prevention mechanism is the entryway stopper connected to a long pull chain. A user may extract the stopper from the draining system by pulling on the chain to remove the stopper from the top of the drain pipe. The second leak prevention mechanism is the pipe valve located inside the drain pipe beneath the aquarium. A user opens the valve, which allows water to flow therepast. When the valve is open, it allows for water to flow from the aquarium and to the hose fitting, which is the third leak prevention mechanism. This hose fitting is preferably a threaded end cap on the end of the drain pipe and allow connection of a drainage hose when disconnected. Alternatively, the hose fitting can be a quick-disconnect fitting that employs a sealable cap to prevent water passage therethrough when a hose is not attached to the system.

Several inventive attempts to address the challenges associated with draining and cleaning aquariums have been made. For example, U.S. Pat. No. 6,761,133 to Gearhart describes a drainable fish tank aquarium. Inside the tank, at the bottom of the aquarium, there is a base having a thickness wherein there is a depressed basin area. The walls of the basin are angled inward toward the center of the basin. The lowest point of the base depression is connected to a drain tube line, which carries water to a drain spout. As the water in the tank drains, the angled walls of the depressed basin, in conjunction with gravity, collect the remaining water and funnel it out the drain tube line to the drain spout. The drain spout is located externally at the bottom of the tank, to one side of the tank. The spout has a valve located inside the drain spout and a small handle located on top of the drain spout such that an individual can easily access the valve handle. An individual manipulates the handle of the valve to control whether the drain spout is open or closed.

The Gearhart device features a single valve, which an individual manipulates to control the flow of the water from of the aquarium. The lack of redundant leak prevention mechanism leaves the Gearhart device prone to unexpected leaks. For example, if an individual forgets to close the valve after draining the aquarium and begins to refill the tank, a leak could occur and the individual can hurriedly close the valve, but is left with a mess to clean up. Similarly, if the valve were to fail completely, the individual would be left with no means of preventing the aquarium from leaking and the device would be rendered useless. The present invention employs a plurality of distinct and redundant leak prevention mechanisms intended to ensure against leakage that could occur in the draining system. One embodiment of the present invention simultaneously utilizes a stopper at the top of the draining system, a rotatable valve inside the draining system, and an engagable hose fitting cap.

Similar to the Gearhart patent is U.S. Pat. No. 6,666,168 to Stutz, which describes a drainable aquarium cleaning system. The aquarium is mounted onto aquarium cabinetry. The cleaning system utilizes gravity and differential pressure gradients to collect precipitates—accumulated waste and other sediments—at the bottom of a tank. This cleaning method does not agitate the water, churn up sediments or upset the tank inhabitants during a partial water change. Rather, the pulling pressure created by the system extracts sediments and waste water from the bottom of the tank. A drain line is located at the center of the bottom of the tank. The drain line either leads directly downward to a waste bucket stored inside a cabinet of the furniture base, or, alternatively, the drain line extends down from the tank a short distance and then bends ninety degrees such that the drain line protrudes out of the side of the furniture base and drains into a waste bucket located outside, and next to, the furniture base. The Stutz device employs the use of a single ballcock valve directly under the base of the aquarium at the beginning of the drain line.

Just as the Gearhart device employs a single valve in the drainage line, the Stutz device too uses a single valve in its drainage system. If the valve were to fail for any reason, there is no alternative, or redundant, leak prevention mechanism in place to stop the entire aquarium from draining. The draining system of the present invention makes use of a series of leak prevention mechanisms to avoid accidental leakage of the aquarium when drainage is not desired. If one of the leak prevention mechanisms were to fail in the present invention, others are still effective and would prevent the aquarium from leaking its contents.

U.S. Pat. No. 6,755,154 to Goldman describes a small aquarium fish tank for use housing a single, or a few, small fish. The tank comprises the walls of the tank, a tank bottom and a through port at the bottom of the tank. The through port can be capped so that water cannot escape through the port, or an agitator air line can be connected to the port. The agitator air line allows for air bubbles to be introduced to the water at the bottom of the tank, which then float upwards to the surface of the water, oxygenating the water. Furthermore, the through port can also serve as a drainage port when the agitator air line is removed. The through port cap is a single mechanism designed to prevent against leaks. If the cap were to fail, or form an improper seal, the tank would leak because the through port is located on the bottom of the tank and gravity facilitates the drainage of water through the faulty port. The present invention has multiple leak prevention mechanisms that stop water from escaping through the draining system when drainage is not desired.

U.S. Pat. No. 7,303,665 to Claudio-Alvardo describes yet another aquarium fish tank that is mounted on the top of aquarium cabinetry. The aquarium portion of the device comprises the traditional four walls of the tank, and a bottom plate that has a plurality of slits—the slits are sufficiently large for debris to filter through, but not so large as to allow the small decorative rock bedding to fall through. Under the bottom plate is a four-walled basin that tapers to form a funnel, which directs the water into a drain pipe. The drain pipe connects to an electronic sensor, which periodically monitors the amount of waste present in the water of the tank. The sensor is a light detector and when unacceptable waste levels have accumulated in the water, the sensor detects such and automatically opens a primary waste valve. The tank flushes a portion of the tank water into a waste bucket located beneath the tank drain pipe inside the aquarium cabinetry.

The Claudio-Alvardo device has a primary valve, a secondary valve and a safety cap located at the hose connection point of the draining system. The high-tech nature of the waste sensor and the sensor regulated automatic valves, suggests that in the event that a draining system component fails, replacement or repair of the faulty part would be complicated to do, as well as expensive. It is likely that aquarium consumers would appreciate a cheaper alternative. Furthermore, it is possible that the automatic valves could fail to close properly, or could drain too much water from the tank if the sensor indicates that there is too much waste in the water and the Claudio-Alvardo device should keep automatically draining the tank. If the device is not monitored by a user, the tank could drain too much, leaving the aquatic animals with insufficient water to survive in, or the waste bucket that the device drains into may overflow. The present invention features manually operated valves and a stopper which are inexpensive and easy to use. The construction of the present invention differs from the Claudio-Alvardo device by incorporating the stopper, which plugs the top of the drain. The purpose of the stopper is to prevent waste from building up in the draining system.

Finally, U.S. Patent Application No. 2009/0,095,226 to Riemma describes a series of tanks which are connected together. The first tank is a tank specifically for the purpose of holding and displaying aquatic life. The second tank is intended for use as a storage tank while the system conditions and stabilizes the water that is to be introduced into the first tank. The Riemma system features redundant check valves and ball valves to prevent back flow and avoid any complications that could result from the failure of a valve. However, the Riemma device does not incorporate a means of preventing fish or small decorative rock bedding from entering the draining system while the aquarium drains. The prescribed drain pipe diameter from the Riemma patent application would easily allow for small fish to accidentally be pulled into the draining system. The present invention incorporates a screen inside the drain pipe, under the stopper, which prevents fish or stone bedding from entering into the drain system. The screen has holes in it which are sufficiently large to allow for waste and debris to pass into the drain.

These prior art devices have several known drawbacks. Aquarium draining systems should incorporate multiple leak prevention mechanisms to ensure against unwanted leakage and redundancy in their construction to prevent damage to a user's home. Furthermore, it is important that the aquatic life contained within the aquarium remains inside the aquarium environment with as little disruption as possible to their habitat. Some draining systems described by the prior art do not provide a means for preventing aquatic life and any decorative bedding from entering the draining system. The present system solves these problems in the art and fulfils a need by providing an inexpensive device compared to the price of an aquarium, and one that ensures the containment of the aquarium fluid when not in use. Further the integrated draining system is easily and inexpensively repairable in the event that a draining system component failure, wherein several layers upstream or downstream prevent inadvertent leakage and allow piecemeal replacement of parts along the system.

The present invention is therefore submitted as being substantially divergent in design elements from the prior art, and consequently it is clear that there is a need in the art for an improvement to existing aquarium drainage devices. In this regard the instant invention substantially fulfills these needs.

### SUMMARY OF THE INVENTION

In view of the foregoing disadvantages inherent in the known types of aquarium drainage systems and devices now present in the prior art, the present invention provides a new aquarium with an integrated draining system wherein the same can be utilized for providing convenience for the user when draining water from an aquarium. Multiple leak prevention mechanisms ensure against accidental leakage of the device and the attachable drainage hose allows for an individual to recycle the discarded water into house plants, if so desired.

It is therefore an object of the present invention to provide a new and improved aquarium drainage system that has all of the advantages of the prior art and none of the disadvantages.

It is yet another object of the present invention to provide an easy, efficient and convenient way for an individual to drain water from an aquarium for cleaning purposes and refill the same.

Another object of the present invention is to provide a drainage system that ensures against accidental leakage both during the draining process and when the draining system is not in use.

Yet another object of the present invention is to provide an aquarium drainage system that employs multiple leak prevention mechanisms, each providing redundancy with regard to leak prevention and inline repairs if necessary.

Another object of the present invention is to provide an individual with a drainage system comprised of manually operated leak prevention components that are inexpensive and simple to replace in the event that a component fails.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 is an exploded perspective view of the components that comprise the disclosed draining system.

FIG. 2 is a cross section view of the present invention in a working position, depicting the integrated draining system and hose fitting without a drainage hose attached and in connection to an aquarium adapted for draining through its base.

FIG. 3 is an underside perspective view of the present invention wherein the integrated draining system protrudes outward from the base of an aquarium tank.

### DETAILED DESCRIPTION OF THE INVENTION

Reference is made herein to the attached drawings. Like reference numerals are used throughout the drawings to depict like or similar elements of the aquarium and integrated draining system. For the purposes of presenting a brief and clear description of the present invention, the preferred embodiment will be discussed as used for draining a fish tank aquarium. The figures are intended for representative purposes only and should not be considered to be limiting in any respect.

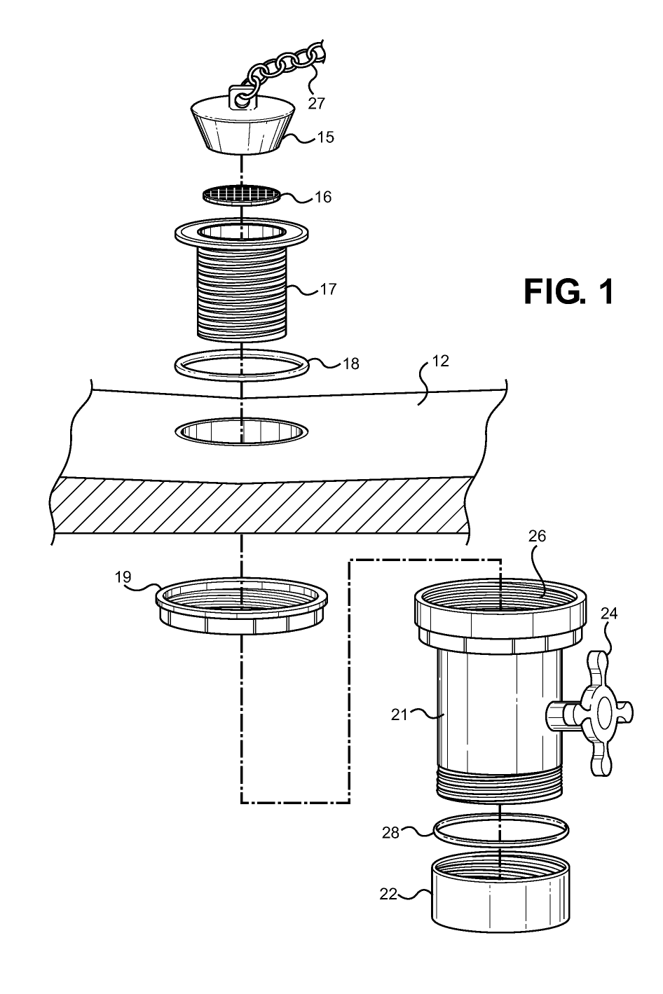

Referring now to FIG. 1, there is shown an exploded perspective view of the components that comprise the aquarium drainage system of the present invention. The drain provides a drainage port through the base 12 of an aquarium, wherein internal fluid contents within the aquarium interior volume are allowed to drain without requiring the user to manually manipulate the aquarium, pour or siphon fluid therefrom when replenishment or drainage is required. The drainage system comprises three redundant leak prevention mechanisms aligned in series with one another, each preventing fluid from the aquarium to flow therepast when in a closed position. The upper most leak prevention mechanism is a removable stopper 15, which fills the drainage port provided by the drain pipe 17 passing through the base of the aquarium 12. Pressure from fluid in the aquarium ensures a tight seal, while the shape is adapted to enter the drain 17 and prevent water from passing therearound when inserted. The drain stopper 15 is preferably connected to a chain 27 that allows a user to remove the stopper without reaching into the aquarium to remove it. Once removed, the user has the option of replacing it during a partial drain by allowing flowing fluid into the drain to draw it into a seated position, cutting off fluid into the drain pipe 17.

The second leak prevention mechanism is a drain valve 24 that is located downstream from the stopper 15 and is connected to the drain 17 by a valve body 21. The drain valve 24 is a fluid valve of any desired type, including butterfly, ball or similar style, wherein fluid is prevented from exiting the drain 17 through the valve body. A hose connection having an end cap 22 is the final leak prevention mechanism along the device, and preferably comprises removable, sealable cap that threadably connects to the valve body 21. The cap 22 connection preferably includes a gasket seal 28 to prevent unwanted leak when the cap 22 is connected. Alternatively, the cap may be replaced with a quick-disconnect valve or similarly closeable and sealable fitting that permits a hose to be attached thereto to affect a fluid connection. When disconnected, the quick-disconnect hose fitting remains closed, preventing fluid from passing therethrough when the stopper 15 and drain valve 24 are in an unseated and open position, respectively. Together, and in either embodiment, the three components that prevent fluid leakage allow the process of draining an aquarium to be carefully controlled, as redundant fluid blockage means prevent inadvertent spilling of aquarium contents when not desired, and further prevent fluid leakage in the event of a singular failure of one of the inline components. Further provided is the ability to replace or repair fittings downstream from the stopper 15 without requiring a complete drain of the aquarium.

The drainage system comprises a series connection of components that affect a water tight seal around a drainage port located along the base of the aquarium. The drain pipe 17 comprises a cylindrical pipe with a larger radius flange along its upper termination that is adapted to be compressed against the interior surface of the aquarium base 12 when installed. Between the drain pipe flange and the base is an elastomeric or similar gasket seal 18 that ensures a water tight connection between the drain pipe flange and the aquarium base. The outer surface of the pipe 17 is preferably threaded to allow engagement of a locking nut 19, which clamps the aquarium base between the drain pipe 17 and the nut 19. Within the interior of the drain pipe 17 is positioned a debris screen 16 to prevent discrete articles from entering the drain hose and creating a clog. The screen 16 preferably rests on an internal shoulder or shelf within the pipe 17, and collects objects thereon as they enter the pipe entryway.

Connecting to a lower termination of the drain pipe 17 is a drain valve body 21. The valve body 21 connects to the outer threading of the pipe 17 using a complimentary threaded, floating nut 26 that is adapted to spin freely along the upper end of valve body in a static position. Each of the disclosed threaded engagements is preferably connected using pipe thread tape that ensures a water tight connection and secure engagement. The pipe valve body 21 is a section of pipe that houses a fluid valve therein and controls fluid flow into a hose fitting at its base, which is adapted to connect to a drainage or fill hose. A valve control or handle 24 is provided on the valve body 21 for controlling the position of the internal valve, either in an on, off or partially closed position and controlling the flow of water into the hose fitting 22.

The hose fitting end cap 22 attached to the valve body 21 comprises the final leak prevention mechanism in the drainage system. This fitting 22 is adapted to prevent water from flowing therethrough prior to connection of a drainage hose. Preferably, the threaded end cap 22 is used to as a final resort against leaks, wherein the stopper 15 and valve 24 are used to prevent water from reach the end cap 22. The end cap 22 is removed to reveal a threaded portion of the valve body 21 in which to affect a connection to a drainage hose. Alternatively, a quick disconnect fitting having an internal valve is provided. Any similar fitting that prohibits fluid leakage until hose connection is achieved is desired, and may be substituted therefor. Once a fluid hose is connected, the stopper 15 can be removed by the user, allowing fluid to flow into the drain pipe and to the valve body 21. The valve control 24 can then be utilized to open the internal valve and allow fluid to flow to the hose fitting, which is connected to a hose and permits fluid to flow thereinto. The opposite end of the hose can be placed into a drainage bucket, sink or other receptacle to collect and discard the draining water. The stopper 15 can be replaced while draining if a partial drain is desired, or alternatively the valve control 24 can be closed to stop the flow of water from the aquarium.

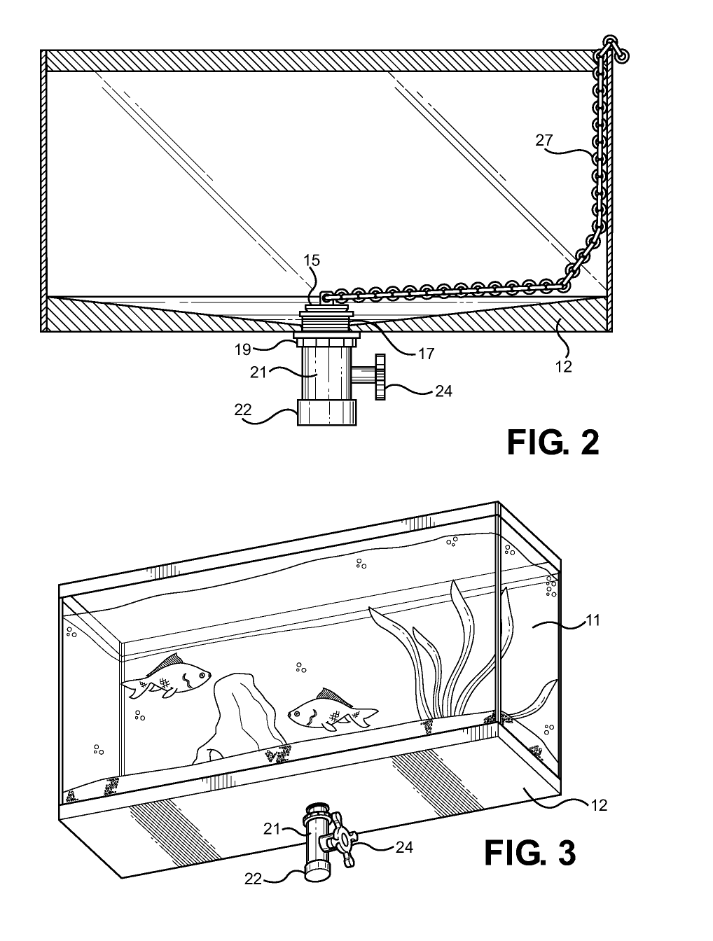

Referring now to FIG. 2, there is shown a cross section side view of the present invention in a working position, installed along the base of an aquarium. The stopper 15 is preferably connected to a pull chain 27 that extends to the upper periphery of the aquarium to allow a user to operate the stopper without reaching into the aquarium. The stopper 15 sits within the drain 17 on the interior side of the aquarium and prevents water from leaking thereinto. To put the stopper into place, an individual must manually inset the stopper into the top of the drain or allow the suction from water draining thereinto to pull the stopper 15 into a seated position within the drain 17. A user may prefer to conceal the stopper 15 and chain 27 with decorative rock bedding if so desired and internal aquarium decorations if desired.

The drain system provides a singular port through which to drain fluid from the base 12 of an aquarium. This task replaces manually tipping, pouring, bucketing or siphoning water from the aquarium, which is otherwise labor intensive, time consuming and potentially messy. An ideal aquarium for use with the present system is one that incorporates a centrally located port with a tapering base to allow water to drain thereinto through the force of gravity, wherein the drain entryway is the lowest portion of the aquarium internal base surface. Centrally locating the drainage components further allows the user to easily grasp the valve control 24 and connect a hose to the hose fitting during draining operations.

Further visualized in FIG. 2 is the drain pipe 17 position through the base of the aquarium. The pipe locking nut 19 compresses the aquarium base between the upper flanges of the drain pipe and the nut, which is threadably engaged from the exterior of the aquarium and torqued into position to affect a tight seal. The internal seal below the drain pipe flange ensures no water leaks past the drain pipe 17 along its exterior and through the port in the aquarium base 12. In this way, all flowing water must enter the passageway of the drain pipe 17 and leaks are prevented and controlled by the leak prevention elements of the system.

The base of the aquarium must be sized with appropriate support to prevent the drainage port from compromising the integrity of the tank, most notably for glass aquariums. Holes or ports through the base of such tanks reduce the integrity of the tank, and limit the effectiveness of the disclosed drainage system. It has been shown in practice that usage of such aquariums may require reinforcement in the way of a layered material sandwiched between the drain plug nut and base, and between the flanges of the drain pipe and the interior side of the aquarium base. The extra layers provide structural support for the drain system through an otherwise fragile sheet of material. Materials contemplated for this reinforcement include Plexiglas and other suitable high strength materials. Alternatively, the base of the aquarium can be sized and composed of an appropriate material such that reinforcement is unnecessary. It is disclosed that such reinforcement may be necessary in aftermarket installations of the drainage system on existing aquariums.

Referring now to FIG. 3, there is shown a perspective view of the present invention depicting the draining system integrated through the base 12 of a fish tank aquarium. The present invention is intended to minimize the amount of disruption that occurs within the aquarium environment during drainage thereof. The tank 11 comprises side walls connected to a base 12, the base having an interior and exterior surface. The tank 11 further comprises a draining system that integrates into the aquarium base and allows gravity-fed drainage through a singular port. The draining system allows for water to exit from the interior of the tank for transfer into another container or receptacle. A drainage hose is connectable to the system, allowing the user to transfer the fluid from within the tank, which may be contaminated or in need of replenishment, out of the tank without manually manipulating the tank. The drainage hose has two ends, a first end that connects to the draining system and a second end that an individual uses to direct the discarded fluid from the tank. An individual uses the second end of the hose to dispose of the waste water by directing it into a sink, a bucket or similar disposal device, or recycling the discarded aquarium water by using the drainage hose and the discarded aquarium water to water house plants. Once drained to satisfaction, the aquarium can be refilled using the same drainage system, but in a reverse order. The end of the hose may be connected to a water faucet or water pump source, wherein water is sent into the aquarium through the drainage port.

In both directions, the drainage system comprises several elements that allow fluid flow from and to the tank internal volume, while eliminating any risk of leakage or accidental drainage therefrom. Three primary components function to provide levels of redundancy and leak prevention, these components are a drain plug, a drain valve and a hose connector for mating a hose with a quick disconnect valve or similar fitting thereto. To use the present invention, an individual pulls out the stopper from the entryway of the drain pipe via the pull chain. Contaminated water passes through a screen as it enters the drain, which prevents fish and decorative rock bedding from passing therethrough. Next, an individual attaches a hose to the hose fitting. Once the hose is secured to the hose fitting, the individual may open the pipe valve by rotating the valve handle. Waste water flows from the aquarium and out through the hose. When drainage completes to the satisfaction of the individual, the individual closes the pipe valve by rotating the valve handle. Next, the individual can replace any of the drained water with a fresh supply by sending the water through the hose and drainage system in reverse order. Once drainage and replenishment is completed, the user replaces the stopper manually by reaching into the interior of the tank and returning the stopper to the top of the drain pipe. It is important to open the pipe valve a second time, once the stopper is in place, to release any remaining water that may be trapped in the draining system. If not cleared, waste in the trapped water settles in the draining system, creating build-up, which can impact the effectiveness of the draining system over time. Finally, the individual removes the hose from the hose fitting. After the draining and replenishment process is complete, the aquarium water has been replaced with a quantity of fresh, uncontaminated water.

The present invention pertains to an aquarium tank with an integrated draining system at its base. The drainage system facilitates water transfer from and into the interior of the aquarium in a controlled fashion. By attaching a hose to the draining system, an individual may drain the discarded aquarium water into a sink, bucket, house plant or other disposal device. For control over the drainage process, the present invention employs a plurality of leak prevention mechanisms that require manual operation by an individual. The leak prevention mechanisms are redundant to ensure against leakage in the draining system. One embodiment of the present invention utilizes a stopper at the top of the draining system, a rotatable valve inside the draining system, and a hose fitting for use when the hose is not attached to the draining system. The leak prevention mechanisms are intended for simultaneous use. A screen inside the drain prevents objects and aquatic life from accidentally entering the draining system. Repair of the system components is further provided without requiring the user to completely drain the aquarium. Specifically, the valve body and hose fitting can be replaced if inoperably or leaking if the stopper is retained in place. Overall, the system provides a novel means to drain an aquarium and to replace or repair its components with minimal time and effort.

With regard to the present disclosure, it is submitted that the present invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An aquarium tank with an integrated draining system, comprising:
an aquarium tank having a base and an interior volume;
a draining system attached through a port along said base allowing fluid to flow from said aquarium interior volume and therethrough, said system comprising redundant leak prevention elements;
said redundant leak prevention elements comprising a drain stopper, a pipe valve and a hose fitting adapted to prevent fluid passage therethrough until connection of a hose is achieved.

2) The device of claim 1, wherein said draining system further comprises:
a drain pipe having an upper and lower termination, a debris screen within said drain pipe, a valve body housing said pipe valve and having a valve handle control, said valve body controlling fluid flow to said hose fitting.

3) The device of claim 2, wherein:
said drain pipe further comprises a flange at its upper termination and threading about its outer surface;
a drain nut threadably engaged onto said drain pipe threading from said aquarium exterior, said drain nut compressing said aquarium base between said drain pipe flange and said drain nut;
a washer seal between said flange and said aquarium base to affect a water tight seal;
said valve body connecting to said drain pipe threading from said aquarium exterior using a threadably engaged nut.

4) The device of claim 1, wherein said stopper further comprises a pull chain to allow removal thereof without reaching into said aquarium interior volume.

5) The device of claim 1, wherein said hose fitting further comprises a threaded connection adapted to accept a drainage hose while in use, and an end cap when not in use to prevent fluid passage therethrough.

6) The device of claim 1, wherein said hose fitting further comprises a quick-disconnect valve adapted to accept a drainage hose while in use, and remain closed when not in use to prevent fluid passage therethrough.

7) The device of claim 1, wherein said drainage system is installed on an aquarium with a tapering base surface, wherein said drainage pipe entryway is at a low point in said aquarium.
